(19) United States
(12) Patent Application Publication
(10) Pub. No.: US 2005/0172744 A1
(43) Pub. Date: Aug. 11, 2005

(54) Reduction gear and method and apparatus for manufacturing the reduction gear concerned, and electric power steering system with the reduction gear concerned

(75) Inventors: Takashi Koyama, Maebashi-shi (JP); Yuji Kawamura, Maebashi-shi (JP); Toshihito Endo, Maebashi-shi (JP)

Correspondence Address: MILES & STOCKBRIDGE PC, 1751 PINNACLE DRIVE, SUITE 500, MCLEAN, VA, 22102-3833, US

(73) Assignees: NSK Ltd.; NSK Steering Systems Co., Ltd.

(21) Appl. No.: 11/055,606

(22) Filed: Feb. 11, 2005

Related U.S. Application Data
(63) Continuation-in-part of application No. PCT/JP04/12132, filed on Aug. 18, 2004.

(30) Foreign Application Priority Data
Aug. 18, 2003 (JP) 2003-294438

(51) Int. Cl. B62D 5/04

(52) U.S. Cl. 74/425; 74/388 PS

(57) ABSTRACT

A reduction gear including: a worm wheel, the tooth skin portion of which is at least made of macromolecular composite material, and a worm for meshing with the worm wheel concerned, wherein a tooth surface of the worm has been heat-treated by high-frequency induction hardening.

This application is a continuation-in-part application of International Application No. PCT/JP2004/012132, filed on Aug. 18, 2004, which claims the benefit of Japanese Patent Application No. 2003-294438 filed on Aug. 18, 2003.

### BACKGROUND OF THE INVENTION

1. Field of the Invention

The present invention relates to an electric power steering system to be used for a vehicle, and more particularly to improvement of a worm to be used for a speed reduction mechanism for transmitting power from a motor.

2. Related Background Art

In a vehicle such as an automobile, in order to decrease a manual steering force caused by steering a steering wheel, an electric power steering system for electrically applying an auxiliary steering force has been used. In order to apply a motor driven auxiliary steering force to a rack shaft, an electric motor has been used. The steering force from the steering wheel is assisted by an electric motor through a speed reduction mechanism, and both ends are coupled to left and right wheels to transmit to the rack shaft which moves in an axial direction.

Also, in the electric power steering system, as a speed reduction mechanism for transmitting power of the electric motor, generally, a worm and a worm wheel have been used. Although for the worm wheel, synthetic resin has been used for anti-noise countermeasure during meshing, as output from the electric motor increases, there may be cases where reinforced fiber is mixed to raise the gear strength.

Since the reinforced fiber in the worm wheel may attack the worm, it is necessary to raise at least hardness of a tooth surface for meshing with the worm wheel. For this reason, conventionally the tooth surface has been given carburizing hardening treatment, nitriding treatment or plating treatment or the like. As these examples, there have been known Japanese Patent Application Laid-Open Nos. 2001-122135 and 2002-213576. Also, as regards induction hardening, Patent No. 2779760 has been known.

In the carburizing hardening treatment, however, there is a problem that deformation after the treatment is great and carburizing hardening equipment is large-sized and has also a long processing time period.

In the nitriding treatment, after the treatment, the surface becomes rough, and after the nitriding treatment, finish grinding becomes necessary. Also, the nitriding treatment is batch treatment, and the incidental facilities are also apt to become equipment on a large scale, and further, there is a problem that the processing time period also becomes longer. Also, although it is smaller than the carburizing hardening treatment, the deformation after the treatment has been also a problem.

Since high precision is demanded of the worm teeth of the electric power steering system, there is a problem that it is necessary in the plating treatment to control strictly. Also, the plating treatment is batch treatment, and the incidental facilities are also apt to become equipment on a large scale, and further, there is a problem that the processing time period also becomes longer.

Also, any of the above-described carburizing hardening treatment, nitriding treatment and plating treatment is not suitable for inline processing, and for this reason, there is also a problem that there is no probability that the productivity will be improved.

### SUMMARY OF THE INVENTION

Thus, it is an object of the present invention to provide a reduction gear capable of performing the inline processing within a short working time period, coping with small-sized treatment equipment while maintaining a predetermined hardness on the tooth surface, and after the treatment, grinding finish work, and a method of manufacturing the reduction gear concerned, and an electric power steering system provided with the reduction gear concerned.

In order to achieve the above-described object, a reduction gear according to the present invention is a reduction gear comprising: a worm wheel, the tooth skin portion of which is at least made of macromolecular composite material, and a worm for meshing with the worm wheel concerned, wherein a tooth surface of the worm has been heat-treated by high-frequency induction hardening.

In order to achieve the above-described object, a method for manufacturing the reduction gear according to the present invention is a method for manufacturing a reduction gear comprising: a worm wheel, the tooth skin portion of which is at least made of macromolecular composite material; and a worm for meshing with the worm wheel concerned, wherein with the worm placed vertically, the tooth surface of the worm is heat-treated by induction hardening.

When the tooth surface of the worm is induction-hardened, it becomes possible to perform inline processing to the same machining line as a before and after process(es), and the working time period becomes shorter. Also, the cost can be restricted. Further, deformation after hardening treatment which occurs also in the case of carburizing hardening treatment and nitriding treatment is comparatively less.

Further, when high-frequency contour induction hardening treatment is performed, overheat can be avoided, and since tooth top melt and a bend of the worm shaft also become smaller, a worm of further higher precision can be obtained. For this reason, improvement of the productivity can be expected.

Also, when material obtained by thermal refining the worm in advance or non-thermal refining steel is used, the structure is stabilized and the hardening hardness is stabilized at a desired hardness. Therefore, a soft metal portion disappears and the wear resistance and the durability are improved.

When the tooth surface of the worm is induction-hardened, it becomes possible to perform inline processing to the same machining line as the before-after process, and the working time period becomes shorter. Also, it requires small-sized processing equipment, and after the induction hardening, grinding work with small allowance for machining will become possible.

Although in usual high-frequency induction hardening treatment, the tooth top of the worm causes overheat so that tooth top melt and a bend of the worm shaft becomes large, when high-frequency contour induction hardening treatment is adopted, overheat can be avoided, and tooth top melt and a bend of the worm shaft also become smaller.

Also, when material obtained by thermal refining in advance or non-thermal refining steel is used, the structure is stabilized and the hardening hardness is stabilized. In this case, for the material obtained by thermal refining, there is material obtained by hardening and tempering medium carbon steel (carbon content: about 0.3 to 0.6%), and the non-thermal refining steel is steel having the same characteristic as conventional steel by omitting a refining process such as hardening and tempering, and there is steel obtained by introducing B (boron) to improve the harden ability, and reducing alloying elements such as Si and Mn to improve the formability in cold forging.

Also, if hardening output, hardening time period and the like are adjusted, only by high-frequency hardening crude material, a worm having desired hardness can be manufactured at low cost. Since the hardening time period has been made longer than a case of contour hardening, carbon diffuses, ferrite decreases and an amount of ferrite residue in a range of hardening the worm is 0 to 10%.

Since it is manufactured with the worm placed vertically, it is possible to prevent the worm shaft from being bent of its own weight, and cooling can be prevented from becoming uneven.

In the present specification, the term “hand drum-shaped” means for example, a shape both axial ends of which have a larger or largest diameter and intermediate portion between the ends has a smaller or smallest diameter.

### BRIEF DESCRIPTION OF THE DRAWINGS

FIG. 1 is a front view (partially exploded) showing a first example according to the present invention;

FIG. 2 is a partial cross-sectional view of FIG. 1;

FIG. 3 is an axial partial cross-sectional view showing a worm subjected to high-frequency contour induction hardening treatment;

FIG. 4 is an axial partial cross-sectional view showing a worm subjected to high-frequency induction hardening treatment;

FIG. 5 is a cross-sectional view showing an example in which a hand-drum shaped worm has been used;

FIG. 6 is a cross-sectional view showing an example in which another hand-drum shaped worm has been used;

FIGS. 7A, 7B and 7C are schematic views showing an apparatus for manufacturing a reduction gear according to the present invention, FIG. 7A is a top view, FIG. 7B is a front view, and FIG. 7C is a side view; and

FIG. 8 is a perspective view showing a shape of a heating coil to be used in the manufacturing apparatus of FIGS. 7A to 7C.

### DESCRIPTION OF THE PREFERRED EMBODIMENTS

Hereinafter, with reference to the accompanying drawings, the detailed description will be made of an example of the present invention. In this respect, in these drawings, portions identical are designated by the identical reference numerals. Also, it goes without saying that the following examples explain the present invention exemplifically, and do not limit the present invention in any meaning.

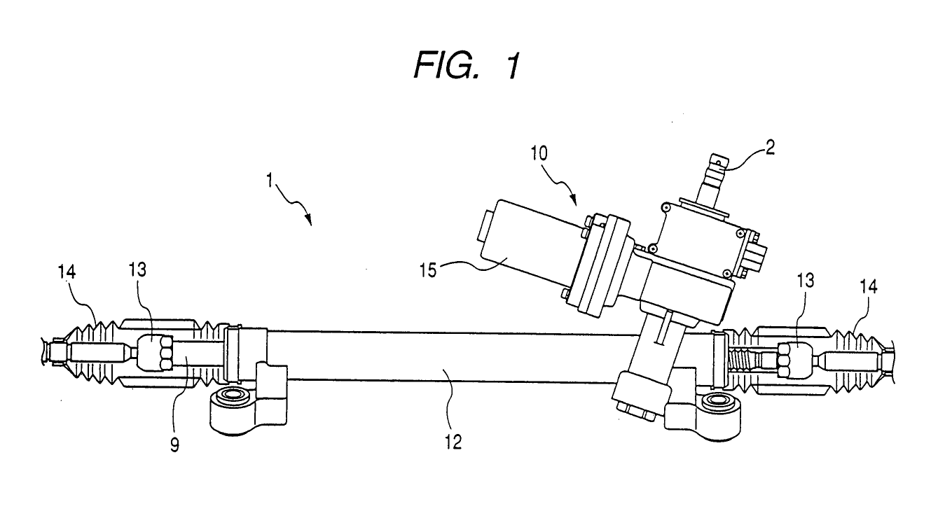

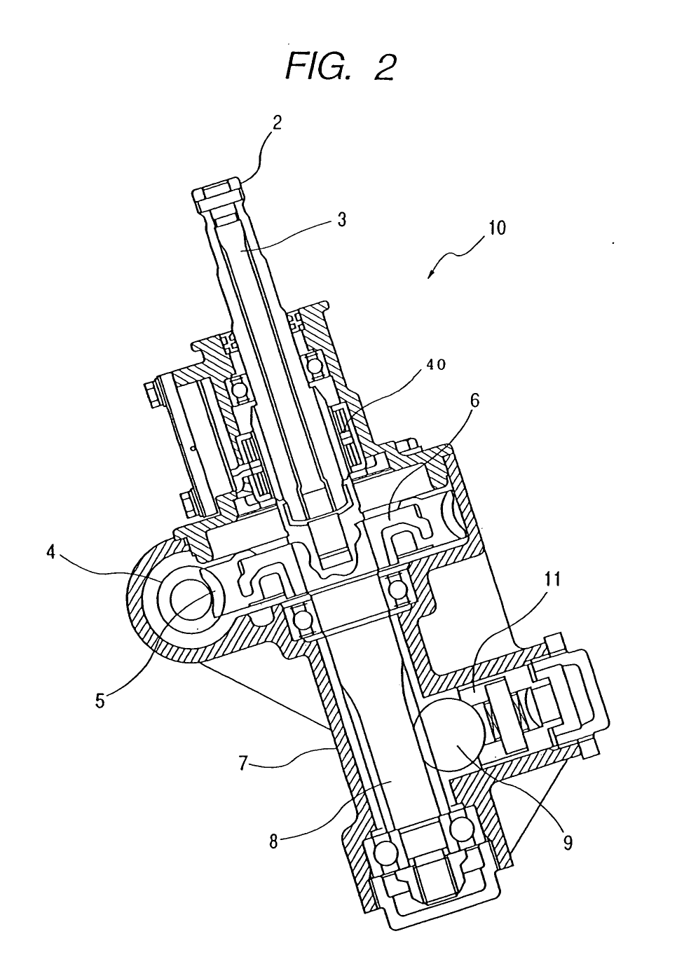

FIG. 1 is a front view (partially exploded) showing an electric power steering system to which an example of the present invention is applicable, and FIG. 2 is an axial cross-sectional view showing an auxiliary steering input portion. A general pinion assist type electric power steering system 1 comprises an auxiliary steering input portion 10 and a cylindrical sleeve 12 in which a rack shaft 9 coupled to the auxiliary steering input portion 10 has been inserted.

Referring to FIG. 2, to an input shaft 2 of the auxiliary steering input portion 10, there is coupled a steering shaft (not shown), to the upper end of which the steering wheel (not shown) has been fixed by means of an universal joint or the like. The input shaft 2 is coupled to a pinion shaft 8, which is an output shaft, through a torsion bar spring 3. The input shaft 2 and the pinion shaft 8 are rotatively supported on a housing 7 by a bearing. With pinion teeth formed on the outer periphery of the pinion shaft 8, rack teeth of the rack shaft 9 mesh. The rack shaft 9 is supported by a pressure pad 11 in such a manner as to be freely movable in an axial direction.

The torsion bar spring 3 is provided with a torque sensor 40; a steering angle due to a driver's operation of the steering wheel is detected by the torque sensor 40 to power-assist in accordance with the amount of torque.

Each end portion of the rack shaft 9 arranged in such a manner as to be freely movable in an axial direction within a cylindrical sleeve 12 fixed to a vehicle, extending in left and right directions of the vehicle is coupled to a steering wheel (not shown) through a ball joint 13. The joint 13 is covered with boots 14.

With the above-described structure,. the pinion shaft 8 is rotated by steering the steering wheel (not shown), whereby a direction of the movement is converted by a rack and pinion mechanism to move the rack shaft 9 in the left and right directions in the axial direction.

Here, with reference to FIG. 2, the description will be made of actuation of the auxiliary steering input portion 10. When there is input from the steering shaft (not shown) to the input shaft 2 of the auxiliary steering input portion 10, power is transmitted to the pinion shaft 8, which is an output shaft, through the torsion bar spring 3. On the outer periphery of the pinion shaft 8, there are provided a worm wheel core bar 6 made of metal and the worm wheel 5 made of resin, and the worm wheel 5 meshes with a worm 4 fixed to the rotating shaft of the electric motor 15.

The electric motor 15 is connected to an on-board CPU (not shown). To this CPU, information on output from the torque sensor 40, vehicle speed and the like is inputted, and a predetermined signal is supplied to the electric motor 15 to generate appropriate auxiliary torque. The electric motor 15 is controlled by CPU on the basis of such information, the rotation is reduced through the worm 4 and the worm wheel 5, and is transmitted to the pinion shaft 8, which is an output shaft. The steering force is assisted by the above-described mechanism. The worm 4 and the worm wheel 5 constitute the reduction gear.

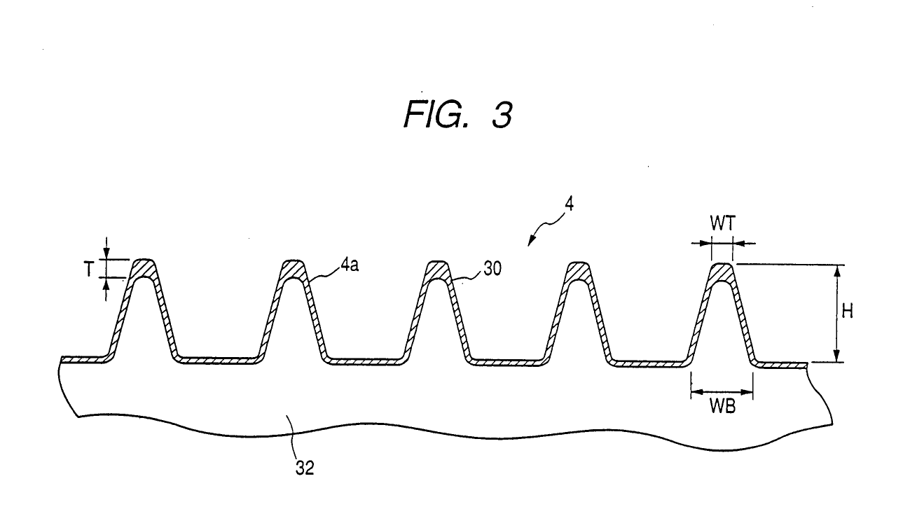

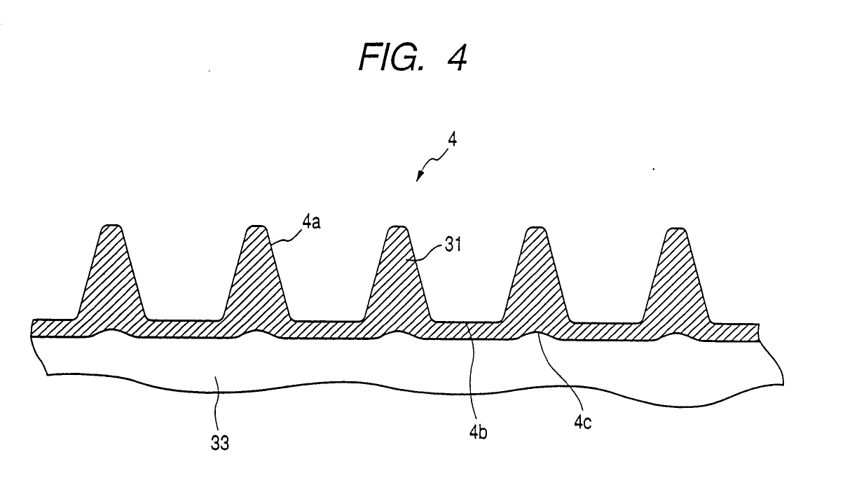

Next, with reference to FIGS. 3 and 4, the detailed description will be made of heat treatment of the worm 4. First, for the material of the worm 4, material obtained by thermal-refining crude material of medium carbon steel of S35C to S50C or the like or steel not yet thermal-refined is used, and particularly boron steel is preferable. When material obtained by thermal-refining as a worm in advance, or the above-described non-thermal refining steel is used, there is an advantage that the structure is stabilized and the hardening hardness is stabilized.

The worm wheel 5 for meshing with the worm 4 is a worm wheel made of macromolecular composite material. As reinforcement material for the macromolecular composite material, for example, fibrous one (glass fiber), or particulate toughened beads or their chemical intermediates, further whisker and the like can be also used. Since, however, reinforcement material having high hardness in the worm wheel 5 attacks and wears the worm 4, it is necessary that the surface hardness of the tooth surface of the worm 4 for meshing with the worm wheel 5 be made to be at least H_{R}C 50 (Hv 513) or higher. In particular, a range of H_{R}C 50 to 63 is suitable. Further, it is preferable to be harder than the reinforcement material mixed in the worm wheel 5 made of resin.

In order to harden an outer periphery including a tooth top 4a of the worm 4, heat treatment is performed by high-frequency induction hardening. FIG. 4 is an axial partial cross-sectional view showing the worm 4 having a hardening pattern hardened by a usual high-frequency induction hardening process. The hardening pattern is obtained by cutting, grinding, alcohol nitrate corrosion, or the like. Generally, teeth of a worm for an electric power steering system are thin-walled, and a hardening area 31 has reached the core portion of the teeth as shown.

The tooth top may cause overheat, leading to tooth top melt and a large bend of the shaft. In FIG. 4, when thermal refining steel is used as the material, on the inner diameter side of a hardening region 31, which is martensite, there exists a non-hardening region 33. Also, in the case of non-thermal refining steel, on the inner diameter side of a hardening region 31, which is ferrite martensite, there exists a non-hardening region 33. This non-hardening region 33 is a range of sorbite in the case of the thermal refining steel, and is a range of ferrite-pearlite for the non-thermal refining steel. The non-hardening region 33 is located on the inner diameter side from a tooth bottom 4b extending in the axial direction.

FIG. 3 is an axial partial cross-sectional view showing the worm 4 having a hardening pattern hardened by a high-frequency contour induction hardening process for high-frequency hardening only a contour portion of a tooth. When the high-frequency contour induction hardening is performed as shown in FIG. 3, since heating energy runs along the skin and the heating energy is given for cutting at high output instantaneously, the tooth top 4a of the worm 4 is less overheated, and the tooth top melt and the bend of the shaft also become smaller, and a better result can be obtained. For the above-described reason, as shown, the high-frequency induction hardening region 30 has substantially uniform depth from the tooth surface to the tooth bottom with the exception of the apex portion of the tooth top 4a.

In FIG. 3, when thermal refining steel is used as the material, on the inner diameter side of a hardening region 30, which is martensite, there exists a non-hardening region 32. Also, in the case of non-thermal refining steel, on the inner diameter side of a hardening region 30, which is ferrite martensite, there exists a non-hardening region 32. This non-hardening region 32 is a range of sorbite in the case of the thermal refining steel, and is a range of ferrite-pearlite for the non-thermal refining steel. In this respect, the thermal refining steel is steel hardened and tempered, and has fine structure and high toughness.

The deceleration worm 4 of the electric power steering system 1 has smaller deddendum width WB (tooth thickness) and tooth top width WT than the tooth depth H in order to secure the strength of the opponent worm wheel 5 made of resin. Also, since as shown in FIG. 3, the apex portion of the tooth top 4a of the worm 4 has small width, hardening is apt to enter deeper than other portions. In this respect, each dimension is to be measured at a cross section at right angles to the tooth.

In the electric power steering system, as regards a relationship between the tooth depth H and the deddendum width WB, there may be also cases where, for example, a relation of H/WB>=1 is satisfied, and it is characterized in that it is a thin-walled tooth in an axial direction as a whole.

Next, the description will be made of test conditions of the high-frequency contour induction hardening based on the present invention and their results.

1. Material

S45C (thermal refining material) and S25C (thermal refining material) have been used.

2. Heat Treatment Condition

Equipment: 1000 Kw in output, 200 KHz in frequency transistor type high-frequency induction hardening system

Shape of heating coil: saddle type coil

Amount of cooling water: 50 liters/minute (cooled from three directions)

The high-frequency contour induction hardening shown in FIG. 3 has been performed at output of 400 Kw and for a heating time period of 0.34 s, and the high-frequency contour induction hardening shown in FIG. 4 has been performed at output of 200 Kw and for a heating time period of 1.3 s. A shape of the coil to be used is considered, the frequency is increased, the output is increased, the cooling speed is raised among other things, whereby the high-frequency contour induction hardening can be controlled.

Table 1 is a table showing test results conducted under the above-described test conditions of the example. As regards a product obtained by performing the high-frequency contour induction hardening through the use of crude material S45C, desired surface hardness has been obtained by such a hardening pattern substantially along the tooth form as shown in FIG. 3. Also, in even a product obtained by performing usual high-frequency induction hardening through the use of crude material S45C, the satisfactory surface hardness has been obtained. A product obtained by performing the high-frequency contour induction hardening through the use of crude material S25C has been hardly hardened.

TABLE 1

| | | | Surface hardness | |
|---|---|---|---|---|
| | | | (0.1 mm from surface) | |
| | | | Tooth surface | Tooth bottom |
| (1) | S45C | High-frequency contour | about 650 Hv | about 650 Hv |
| | | induction hardening | | |
| (2) | S45C | High-frequency | about 700 Hv | about 650 Hv |
| | | induction hardening | | |
| (3) | S25C | High-frequency contour | about 350 Hv | about 450 Hv |
| | | induction hardening | | |

Table 1 shows data after tempering.

In the case of the high-frequency contour induction hardening, there remains ferrite, and although there are somewhat variations in harness, the hardening structure has been sufficiently satisfactory. Also, the outside appearance has been good without overheat or the like. Further, in the case of the high-frequency contour induction hardening, it has turned out that an amount of deformation after the heat treatment is smaller than in the high-frequency induction hardening.

As regards hardening depth, in Table 1, in the case of (1), about 0.4 mm at the tooth bottom, about 0.4 mm at the inclined plane portion, about 1.8 mm at the tip portion, in the case of (2), about 0.6 mm at the tooth bottom, about 4.3 mm from the tip portion, in the case of (3), about 0.1 mm at the tooth bottom, no hardening at the inclined plane portion and the tip portion. In this regard, the tooth depth is 5.5 mm in (1) to (3) in common.

Preferably, the high-frequency (induction) tempering may be performed to the tooth surface of the worm heat-treated by high-frequency (induction) hardening. The condition for the high-frequency (induction) tempering is as follows.

1. Frequency: 300 KHz

2. Output: 230V

3. Heating time: 6.5 sec

In general kiln heating, a total heating time, namely the sum of time for raising temperature and maintaining the temperature will be longer, and batch process is inevitable. Accordingly, a large-sized kiln is required and it is difficult to build the apparatus in the inline system.

According to the present invention, using the high-frequency (induction) tempering apparatus of 3 Khz, it is possible to shorten the heating time, convey by a small lot and make the system compact as compared with the kiln tempering.

The hardness of the tooth surface of the worm heat-treated by high-frequency (induction) tempering and conventional kiln tempering is as follows. It is seen that the hardness by high-frequency induction hardening can be greater than by conventional kiln hardening.

High-frequency (induction) tempering:

Hv669-708 (3 Khz, output 220V, 6.5 sec)

Conventional kiln tempering:

Hv619-680 (180° C. for one hour)

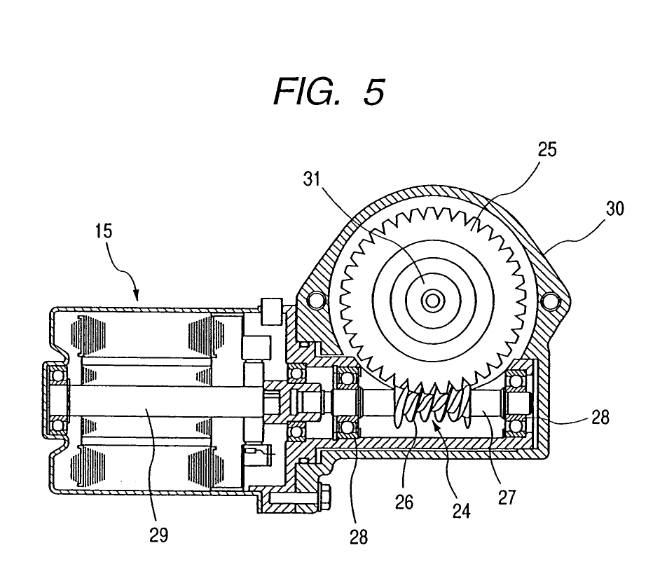

The present invention explained above can be adopted for the hand drum-shaped worm. Also, when it is adopted for a worm having a module of 3 or less, it is further suitable. FIG. 5 is a cross-sectional view showing an example in which the hand drum-shaped worm has been used. Within the case 30, there is provided a worm wheel 25 made of macromolecular composite material fitted in the outer periphery of the pinion shaft 31, and the worm wheel 25 meshes with the hand drum-shaped worm 24.

“Module” adopted in the present specification is, for example, “normal module” described in “KHK General Catalog. Gear Technical Data 3008 vol.6” of Kohara Gear Industrial Co. LTD., and tooth form of the cylindrical worm is of JIS B1723.

The hand drum-shaped worm 24 is formed on a worm shaft 27 supported on the bearing 28, and has a tooth 26, the diameter of which is the largest at both ends in the axial direction, and is a minimum at the center. The worm shaft 27 is fixed to a rotating shaft 29 of the electric motor 15. When the hand drum-shaped worm is used, the load-carrying ability has an allowance to spare. In other words, there is an advantage in its capability to transmit large power. This is because in the hand drum-shaped worm 24, since all the teeth of the worm effectively mesh with the worm wheel 25, a number of teeth for meshing becomes exceedingly great, and surface pressure of the mating surfaces becomes lower.

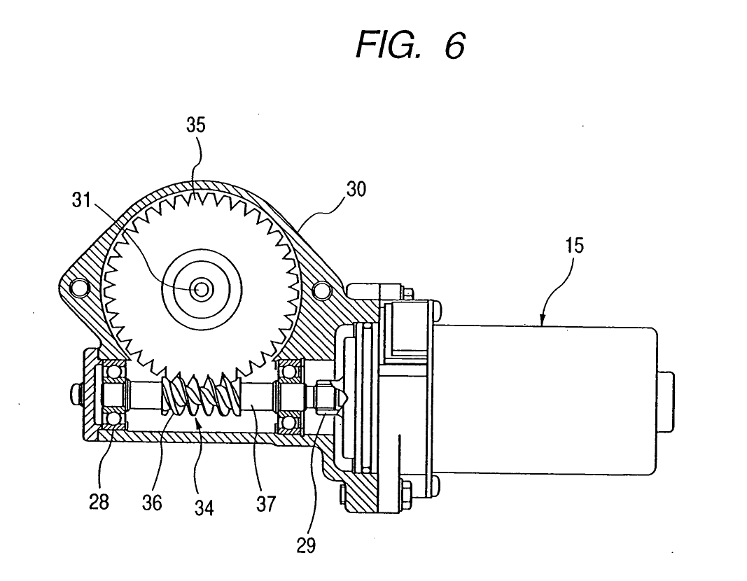

FIG. 6 is a cross sectional view showing an example in which another hand drum-shaped worm has been used. Within the case 30, there is provided a worm wheel 35 made of macromolecular composite material fitted in the outer periphery of the pinion shaft 31, and the worm wheel 35 meshes with a hand drum-shaped worm 34.

The hand drum-shaped worm 34 is formed on a worm shaft 37 supported on the bearing 28, and has a tooth bottom, the diameter of which is the largest at both ends in the axial direction, and is a minimum at the center although equal in the outer diameter of the worm tooth 36. The worm shaft 37 is fixed to a rotating shaft 29 of the electric motor 15. In this case, it is different from an ordinary worm in that the diameter at the tooth bottom of the hand drum-shaped worm 34 is smaller than in the usual case at the center in the axial direction. This corresponds to the outer diameter of the worm wheel 35 being larger. The advantage is substantially the same as in the case of FIG. 5, but the worm wheel shown in FIG. 6 is easier than FIG. 5 to fabricate.

Next, the description will be made of a method for manufacturing a reduction gear according to the present invention. There will be manufactured a reduction gear comprising: a worm wheel, the tooth skin portion of which is at least made of macromolecular composite material, and a worm for meshing with the worm wheel concerned. With the worm placed vertically, the tooth surface of the worm is heat-treated by high-frequency induction hardening.

The worm is placed vertically in order to prevent the worm shaft from bending of its own weight, and to prevent cooling from becoming uneven.

If the worm is made of material obtained by thermal- refining or non-thermal refining steel, high-frequency contour induction hardening will be performed with heating energy output of 550-600 Kw or, in the present example, 600 Kw, and for a heating time period of 0.30 to 0.50 seconds, or, in the present example, 0.35 seconds, whereby a worm (See FIG. 3) having surface hardness of Hv 550 has been obtained.

Since, however, if the worm is made of steel not thermal-refined, desired hardness cannot be obtained under the above-described conditions, when the module is 2.65, high-frequency induction hardening will be performed with heating energy output of 250 to 300 Kw, or, in the present example, 300 Kw and for a heating time period of 0.60 to 1.00 seconds, or, in the present example, 0.60 seconds. Generally, if a numerical value of the module becomes smaller, the output will become lower and the time period will become shorter. If the numerical value of the module becomes larger conversely, the output will become higher and the time period will become longer. Thereby, there has been obtained a worm (See FIG. 4) having surface hardness of Hv 550 or higher with deformation within the latitude, the hardening pattern of which does not form the contour. This will be called “Non-contour hardening”, and the non-hardening region 33 is located on the inner diameter side from tooth bottom 4b extending in the axial direction. When steel not thermal-refined is used as described above, small heating energy is required, and therefore, small equipment will suffice, and since the material is also low-priced, the manufacturing cost also becomes low. In both the above-described high-frequency contour induction hardening and the high-frequency induction hardening, the arrangement is made so that a value obtained by multiplying the output (Kw) by time period (second) becomes 150 to 300.

Hereinafter, using numerical value data, the description will be made of basic features of a worm manufactured by means of the above-described manufacturing method through the use of crude material as material which is not non-thermal refining steel, but has not been thermal-refined in advance, that is, steel not thermal-refined.

(1) Amount of ferrite residue: 0 to 10%

(This is a numerical value within a range of hardening after the high-frequency induction hardening/high-frequency tempering, and has been obtained by image-analyzing the micrograph. Measured at depth of 0.25 mm from the upper surface of PCD before grinding. After grinding, it corresponds to 0.20 mm from the surface.)

(2) Amount of carbon of worm material: 0.42 to 0.48% (corresponding to S45C)

(Obtained by measuring the crude material by a combustion-infrared rays absorption method)

(3) Amount of ferrite of worm material: 10 to 40%

(After the heat treatment, obtained by image-analyzing the micrograph for the core portion (outside the range of hardening) of the worm.)

(4) Surface hardness of the worm after the high-frequency induction hardening/high-frequency tempering: Hv 550 to 770

(Obtained by measuring with a Vickers hardness tester 5 Kg. Measured at depth of 0.25 mm from the surface before grinding. After grinding, it corresponds to 0.20 mm from the surface.)

(5) Hardness of cored portion of the worm (corresponding to the material hardness) : H_{R}C 22 to 28

(Obtained by measuring with a Rockwell hardness tester C scale)

In this case, as shown in (1), the amount of ferrite has become as comparatively a low value as 0 to 10% because since the hardening time period has been made longer than in the case of the contour hardening, carbon diffuses and ferrite decreases.

Also, Hv 550 to 770 has been assumed as shown in (4) because if Hv does not exceed 550, it will wear out because of glass fiber which exists in the resin in the tooth surface of the worm wheel and if Hv is assumed to be 770 or less, it will be able to have toughness and to prevent from being cracked.

As described above, if the high-frequency contour induction hardening is not performed, but the hardening output, hardening time period and the like are adjusted, it is possible to manufacture a worm having desired hardness at low cost only by high-frequency induction hardening the crude material.

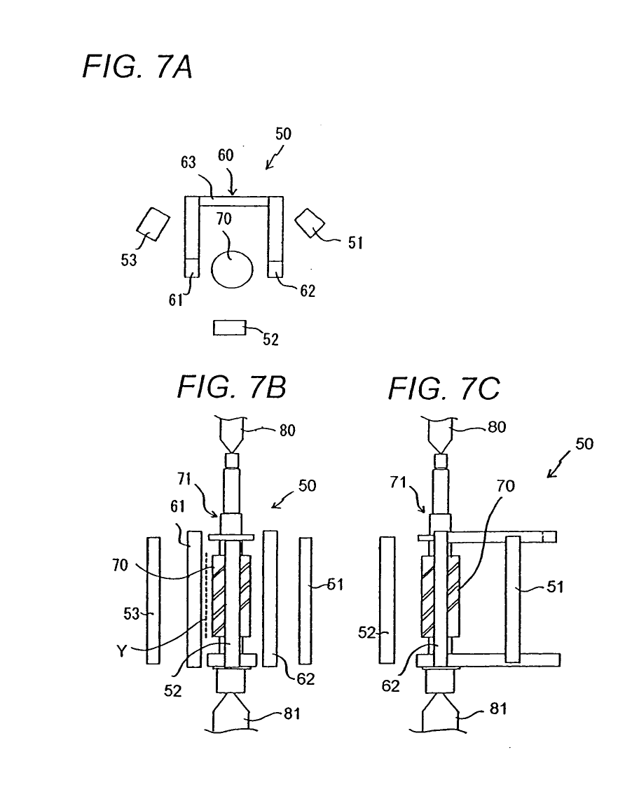

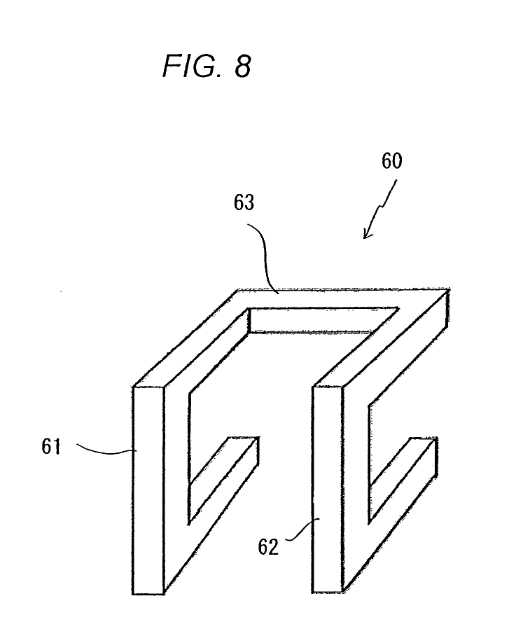

Next, with reference to FIGS. 7A to 7C and FIG. 8, the description will be made of a hardening apparatus to be used in a method for hardening the worm according to the present invention. FIGS. 7A to 7C are schematic views showing an apparatus for manufacturing a reduction gear according to the present invention, FIG. 7A is a top view, FIG. 7B is a front view, and FIG. 7C is a side view. Also, FIG. 8 is a perspective view showing a shape of a heating coil to be used in the manufacturing apparatus of FIGS. 7A to 7C.

As shown in FIGS. 7A to 7C, the hardening apparatus 50 supports a work 71 for fixing the worm 70 by centers 80 and 81 from above and below. The work 71, that is, the worm 70 is placed in parallel in a vertical direction, and has been placed in a vertically-placed state.

A heating coil 60 is arranged so as to sandwich the worm 70 in a circumferential direction. The heating coil 60 is a saddle type coil as shown in FIG. 8, and is constructed of U-character shaped vertical portions 61 and 62, and a coupling portion 63 for integrally coupling those vertical portions.

Also, in the outside of the heating coil 60, three cooling jackets 51, 52 and 53 are arranged at predetermined intervals. Axial length of the cooling jackets 51 to 53 is substantially equal to the vertical portions 61, 62 of the heating coil as shown in FIGS. 7B and 7C, but is not necessarily required to be equal. Any length may be taken as long as, for example, the vertical portions 61, 62 of the heating coil 60 has at least longer axial length than a range of hardening Y of the worm shown in FIG. 7B.

In the hardening apparatus 50 having such structure as described above, the work 71, that is, the worm 70 is hardened while it is being rotated at a predetermined number of revolutions by a driving unit (not shown).

This application claims priority from Japanese Patent Application No.2003-294438 filed on Aug. 18, 2003, which is hereby incorporated by reference herein.

1. A reduction gear comprising: a worm wheel, a tooth skin portion of which is at least made of macromolecular composite material, and a worm for meshing with said worm wheel, wherein
a tooth surface of said worm has been heat-treated by high-frequency induction hardening.

2. The reduction gear according to claim 1, wherein said high-frequency induction hardening is contour induction hardening.

3. The reduction gear according to claim 1, wherein said worm is subjected to grinding process after the high-frequency induction hardening and tempering.

4. An electric power steering system comprising a reduction gear according to claim 1, wherein said worm is made of material obtained by thermal refining or non-thermal refining steel and surface hardness of said worm is Hv 550 to 770, and wherein an amount of ferrite residue in a range of hardening of said worm is 0 to 10% after high-frequency induction hardening and said worm has a module of 3 or less.

5. The reduction gear according to claim 1, wherein said worm is made of steel not thermal-refined.

6. The reduction gear according to claim 5, wherein said high-frequency induction hardening is non-contour induction hardening.

7. The reduction gear according to claim 5, wherein surface hardness of said worm is Hv 550 to 770.

8. The reduction gear according to claim 5, wherein an amount of ferrite residue in a range of hardening of said worm is 0 to 10% after high-frequency induction hardening.

9. The reduction gear according to claim 5, wherein said worm is a hand drum-shaped worm.

10. The reduction gear according to claim 5, wherein said worm has a module of 3 or less.

11. An electric power steering system characterized by having a reduction gear according to claim 5.

12. The electric power steering system according to claim 11, wherein a surface hardness of said worm being Hv 550 to 770 after high-frequency tempering, and said worm has a module of 3 or less, and wherein
a tooth surface of said worm has been heat-treated by high-frequency induction hardening which is non-contour induction hardening through the use of crude material S45C, and an amount of ferrite residue in a range of hardening of said worm is 0 to 10% after high-frequency tempering, and wherein
a relationship between the tooth depth H and the deddendum width WB satisfies a relation of H/WB>=1.

13. A method for manufacturing a reduction gear comprising: a worm wheel, a tooth skin portion of which is at least made of macromolecular composite material, and a worm for meshing with said worm wheel, characterized by heat-treating, with said worm vertically placed, a tooth surface of said worm by high-frequency induction hardening.

14. The method according to claim 13, wherein said worm is subjected to grinding process after the high-frequency induction hardening and tempering.

15. The method for manufacturing a reduction gear according to claim 13, wherein said worm is made of material obtained by thermal-refining or non-thermal refining steel, and high-frequency contour induction hardening is performed with output of about 550-600 Kw for a period of about 0.30 to 0.50 second.

16. A method for manufacturing an electric power steering system having a reduction gear according to claim 13, wherein said worm is made of steel not thermal-refined, and high-frequency induction hardening or high-frequency contour induction hardening is performed with output of about 250 to 300 Kw for a period of about 0.60 to 1.00 second.

17. The method for manufacturing an electric power steering system, according to claim 16, wherein said worm is vertically placed, a tooth surface of said worm is heat-treated by high-frequency induction hardening and high-frequency tempering, wherein high-frequency induction hardening through the use of crude material S45C is performed, and said worm has a module of 3 or less, and wherein a relationship between the tooth depth H and the deddendum width WB satisfies a relation of H/WB>=1.

18. An apparatus for manufacturing a reduction gear comprising: a worm wheel, a tooth skin portion of which is at least made of macromolecular composite material, and a worm for meshing with said worm wheel, wherein said apparatus comprising:
centers for supporting said worm so as to place vertically;
a heating coil for surrounding said worm; and
a cooling jacket for surrounding said worm, and wherein
a tooth surface of said worm is heat-treated by high-frequency induction hardening while said worm is being rotated in a state in which said worm has been vertically placed.
